(19) United States
(12) Patent Application Publication
(10) Pub. No.: US 2008/0079671 A1
(43) Pub. Date: Apr. 3, 2008

(54) INFORMATION PROCESSING APPARATUS AND DISPLAY CONTROL METHOD

(75) Inventors: Hiroshi Yamazaki, Ome-shi (JP); Yoshio Matsuoka, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 11/864,468

(22) Filed: Sep. 28, 2007

(30) Foreign Application Priority Data
Sep. 28, 2006 (JP) 2006-265843

(51) Int. Cl. G09G 3/32

(52) U.S. Cl. 345/82

(57) ABSTRACT

According to one embodiment, an information processing apparatus includes a display unit comprising a plurality of light-emitting devices, a light-emitting unit which, if a predetermined area of the display unit is displayed, urges the plurality of light-emitting devices corresponding to the predetermined area and an area wider than the predetermined area to emit light, and a controller urging a display area other than the predetermined area, in a display range in which the light-emitting devices emit light by the light-emitting unit, to be displayed in black.

### CROSS-REFERENCE TO RELATED APPLICATIONS

This application is based upon and claims the benefit of priority from Japanese Patent Application No. 2006-265843, filed Sep. 28, 2006, the entire contents of which are incorporated herein by reference.

### BACKGROUND

1. Field

One embodiment of the present invention relates to display control technology of a display unit and, more particularly, to an information processing apparatus and a display control method, capable of displaying by uniformly controlling brightness in a display area.

2. Description of the Related Art

In general, as technology of making display on a part of a display unit to save power, display is controlled by turning on backlight corresponding to a part of area to be displayed and turning off the other backlight (cf. JP-A No. 10-207400 (KOKAI)).

According to this technology, however, display is made outside the displayed area due to the area illuminated by the backlight, and the brightness on the periphery of the displayed area is degraded when the area to be illuminated by the backlight is set to be close to the displayed area.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an outer appearance of an information processing apparatus according to an embodiment of the present invention;

FIG. 2 is an exemplary block diagram showing main components of the information processing apparatus according to the embodiment;

FIG. 3 is an exemplary flowchart showing a display control method to which the information processing apparatus according to the embodiment is applied;

FIG. 4 is an exemplary illustration showing a state in which an application window is displayed by controlling turning on or off LED according to the embodiment;

FIG. 5 is an exemplary illustration showing a state in which an application window is displayed by controlling turning on or off LED according to the embodiment;

FIG. 6 is an exemplary illustration showing a state in which display is made in accordance with change of a size of an application window by controlling turning on or off LED according to the embodiment; and

FIG. 7 is an exemplary illustration showing a state in which display is made in accordance with change of a position of an application window by controlling turning on or off LED according to the embodiment.

### DETAILED DESCRIPTION

Various embodiments according to the invention will be described hereinafter with reference to the accompanying drawings. In general, according to one embodiment of the invention, an information processing apparatus, includes: a display unit comprising a plurality of light-emitting devices; a light-emitting unit which, if a predetermined area of the display unit is displayed, urges the plurality of light-emitting devices corresponding to the predetermined area and an area wider than the predetermined area to emit light; and a controller urging a display area other than the predetermined area, in a display range in which the light-emitting devices emit light by the light-emitting unit, to be displayed in black.

An embodiment of the present invention will be described below with reference to the accompanying drawings.

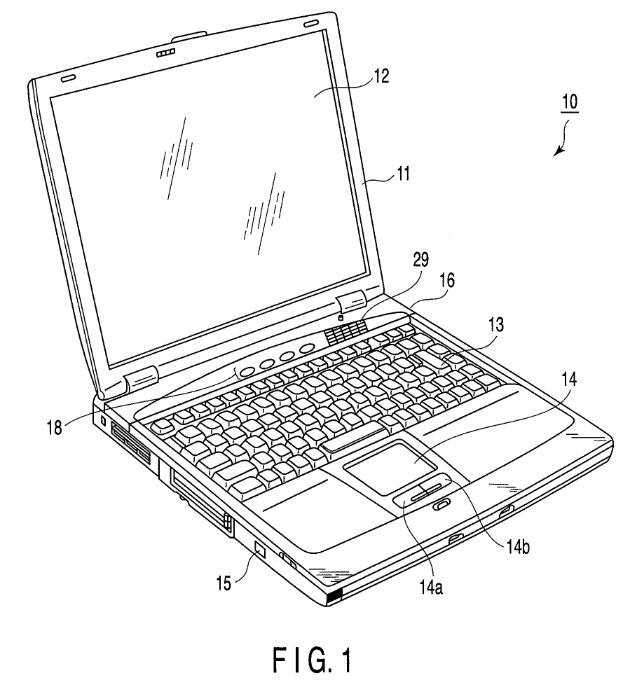

FIG. 1 is a perspective view showing an information processing apparatus according to the embodiment of the present invention. The information processing apparatus is implemented as a battery-operated notebook computer 10.

The present invention turns on a backlight of a display unit in an area where an arbitrary pre-registered application is displayed, and displays the other areas in black, to reduce power consumption. Moreover, the present invention turns on a backlight of an area wider than an area where an application is displayed, makes brightness of the backlight in the area where the application is displayed, and displays areas other than the area where the application is displayed in black.

The computer 10 is composed of a main body 16 and a display unit 11 as shown in FIG. 1. A display device composed of an LCD (Liquid Crystal Display) is embedded in the display unit 11. A display screen 12 of the LCD is located approximately at the center of the display unit 11.

The display unit 11 is attached to the computer 10 so as to freely pivot between an opened position and a closed position. The main body of the computer 10 has a housing shaped in a thin box, and comprises a keyboard 13 on a top face, a touch pad 14 and two buttons 14a, 14b, various kinds of shortcut buttons for mail, etc., a power button, a volume control button 18, a speaker 29 and the like on a palm rest. An optical drive 15 is provided on a side face of the main body 16.

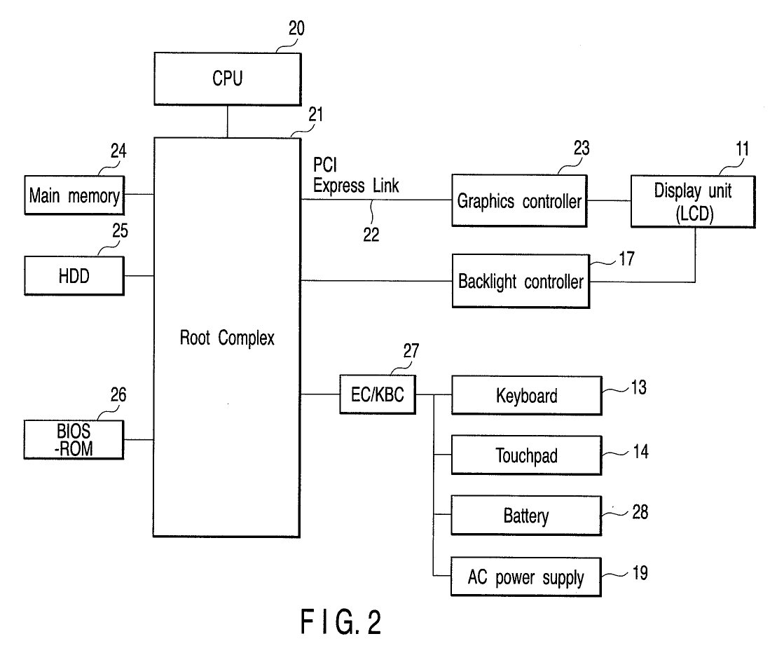

FIG. 2 is a block diagram showing main components of the information processing apparatus according to the embodiment.

The computer 10 comprises a CPU (Central Processing Unit) 20, a Root Complex 21, a main memory 24, a graphics controller (End Point) 23, a PCI Express Link 22 making a connection between the Root Complex (chip set) 21 and the graphics controller 23, the display unit (LCD) 11, a backlight controller 17, an embedded controller/keyboard controller IC (EC/KBC) 27, a hard disk drive (HDD) 25, a BIOS-ROM 26, a keyboard 13, a touch pad 14, a battery 28, an AC power supply 19 and the like.

The Root Complex 21, the graphics controller 23, etc. are devices in conformity with the PCI EXPRESS standards. The communications between the Root Complex 21 and the graphics controller 23 are executed over the PCI Express Link 22 arranged between the Root Complex 21 and the graphics controller 23.

The CPU 20 is a processor controlling the operations of the computer 10, and executes various kinds of programs (operating system and application systems) loaded on the main memory 24 by the HDD 25. In addition, the CPU 20 also executes the BIOS (Basic Input Output System) stored in the BIOS-ROM 26. The BIOS is a program for controlling the hardware such as the graphics controller 23 which serves as a display controller, the backlight controller 17, the display unit (LCD) 11 and the like.

The Root Complex 21 is a bridge device making a connection between a local bus of the CPU 20 and the graphics controller 23. In addition, the Root Complex 21 also has a function of executing the communications with the graphics controller 23 over the PCI Express Link 22.

The graphics controller 23 is a display controller which controls the display unit 11 employed as a display monitor of the computer. In addition, the graphics controller 23 makes a predetermined display in a predetermined area on the display. For example, when the backlight is turned on in an area wider than the displayed area, the graphics controller 23 controls displaying the outer area wider than the displayed area in black.

The EC/KBC 27 is a one-chip microcomputer on which an embedded controller for power management and a keyboard controller controlling the keyboard 13, the touch pad 14, the battery 28, the AC power supply 19 and the like are integrated. The EC/KBC 27 has a function of controlling power-on/power-off of the computer 10, in cooperation with a power supply controller, in response to the user's operation of the power button.

The HDD 25 stores programs such as the operating system, a display control application and the like.

The backlight controller 17 controls turning on and off each of elements of the backlight which comprises a plurality of light-emitting devices, in accordance with commands from the display control application.

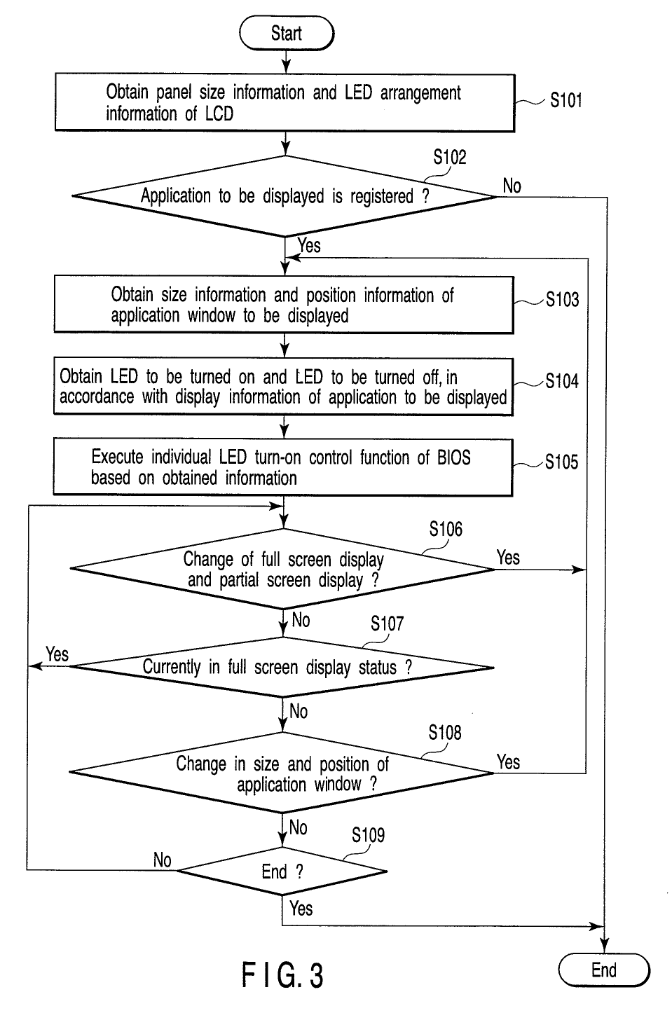

Next, a display control method to which the information processing apparatus according to the embodiment is applied is described with reference to a flowchart of FIG. 3. In the present embodiment, LED is explained as the light-emitting device. However, the light-emitting device is not limited to the LED if it can emit light independently.

First, areas other than the displayed area of the application of interest, of applications displayed on the display unit, are displayed in black (partial screen display), and applications aiming to save power are set (partial screen display setting) and registered. For example, two applications of word processor software and spreadsheet software are registered. This registration is executed for, for example, the display control application stored in the HDD 25.

When the CPU 20 of the computer 10 invokes the display control application from the HDD 25, panel size information of the display unit 11, LED arrangement information, and the like are obtained from the connected display unit (LCD) 11 by the display control application (block S101).

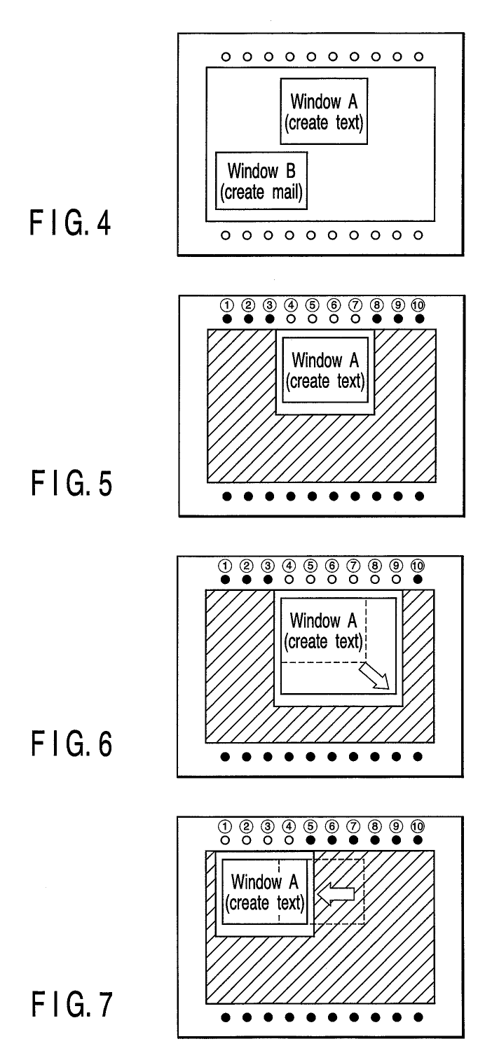

The display control application controlled by the CPU 20 of the computer 10 discriminates whether or not the application to be displayed on the display unit 12 is the registered application (block S102). If it is discriminated by the display control application that the application to be displayed on the display unit 12 is the registered application (YES in block S102), size information and position information of a window of the application to be displayed on the display unit 12 (i.e. window of the application to be displayed) are obtained from the operating system (block S103). On the basis of the obtained display information of the window of the application to be displayed on the display unit 12, the display control application calculates LEDs to be turned on and LEDs to be turned off (block S104). On the basis of the obtained information, the display control application urges the BIOS to execute an individual LED turn-on control function of the display unit via the backlight controller 17 (block S105). By the execution of the individual LED turn-on control function, LEDs are turned on or off on the basis of the obtained display information (size information, position information and the like). For example, when two windows of application A (text creating screen of word processor software) and application B (mail creating screen of mailing software) are displayed as shown in FIG. 4, the LEDs need to be turned on to display the only window of application A since the pre-registered application of the word processor software. As shown in FIG. 5, the window of the application A is displayed by turning on backlight LEDs 4 to 7, by the backlight controller 17 of the computer 10. Moreover, an area wider than the window of the application A is turned on more brightly by turning on the LEDs 4 to 7, the CPU 20 of the computer 10 controls the area outside the window of the application A to be displayed in black.

Next, the display control application discriminates whether or not change of “full screen display” and “partial screen display” has been executed (block S106). The “full screen display” is a display status in which the entire backlight is turned off in a manner of prior art. The “partial screen display” is a display status in which a predetermined application window is displayed in the manner of the present embodiment. If it is discriminated in block S106 that the change of the “full screen display” and the “partial screen display” has been executed (YES in block S106), the operation shifts to block S103. On the other hand, if it is discriminated by the display control application in block S106 that the change of the “full screen display” and the “partial screen display” has not been executed (NO in block S106), and if the current display screen is not the “full screen display” (NO in block S107), the operation shifts to block S108. If it is discriminated by the display control application in block S108 that the size and position of the application window in the “partial screen display” status have been changed, the operation shifts to block S103. If the display control application receives END command (YES in block S109), the display control application ends the operation.

Next, the above change of the size and position of the application window is described.

When the window A is displayed as shown in FIG. 6, the LEDs 4 to 7 are turned on. If the size of the window A becomes larger in this status, LEDs 4 to 9 are turned on in response to the change of the size. The area other than the window A displayed in black so as not to display an area wider than the widow A illuminated by the LEDs 4 to 9.

Moreover, when the window A is displayed as shown in FIG. 7, the LEDs 4 to 7 are turned on. If the position of the window A in this status is changed and the window A is moved to the left side, LEDs 1 to 4 are turned on in response to the change of the position. In the above embodiment, a predetermined area, for example, an area other than the window A is displayed in black (image display OFF), but the display color is not limited and may be blue or the like.

In the present embodiment, as described above, the window of an arbitrary range can be illuminated sufficiently and uniformly by the backlight while the power consumption is reduced. In addition, brightness and darkness can be clearly distinguished and the display range of the window can be uniformly illuminated by turning on the backlight to sufficiently illuminate the display range of the window and displaying the area other than the display area of the window in black. In other words, the brightness of the entire display area can be controlled uniformly by sufficiently increasing the brightness of the backlight up to the outside of the necessary display area.

In the above embodiment, there is one window of the registered application. If two or more windows of the registered application are displayed, these windows can be changed and displayed by a hotkey or the like. In addition, the “full screen display” can be employed during the change process and can be changed with the windows of the registered application.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a display unit comprising a plurality of light-emitting devices positioned over a display area, the display area comprising a first predetermined area and a second area different from the first predetermined area;
a light-emitting unit configured to induce the light-emitting devices corresponding to the predetermined area and an area wider than the predetermined area to emit light when the predetermined area of the display unit is active; and
a controller configured to induce the light-emitting unit to prevent the light-emitting devices in the second area from emitting light.

2. The apparatus according to claim 1, wherein the light emitting unit is configured to induce the light emitting devices corresponding to a changed area of the display unit and an area wider than the changed area to emit light when the range of the predetermined area is changed, and wherein the controller is configured to induce the light emitting unit to prevent the area of the display unit other than the changed area from emitting light such that the area other than the changed area is displayed in black.

3. The apparatus according to claim 2, wherein the range of the predetermined area is configured to be changed by either changing the size or position of the predetermined area to define the changed area.

4. The apparatus according to claim 1, wherein an application displayed in the predetermined area comprises a pre-registered application.

5. The apparatus according to claim 4, wherein if a plurality of pre-registered applications including the pre-registered application are started, the applications are changed in order.

6. A display control method for an information processing apparatus comprising a display unit that comprises a plurality of light-emitting devices positioned over a display area, the display area comprising a first predetermined area and a second area different from the first predetermined area, the method comprising:
inducing the light-emitting devices corresponding to the predetermined area of the display unit and an area wider than the predetermined area to emit light when the predetermined area is active; and
inducing the second area of the display unit other than the predetermined area to be displayed in black.

7. The method according to claim 6, further comprising:
a changed display area and an area wider than the changed display area to emit light when a range of the predetermined area is changed; and
inducing the remaining area of the display unit other than the changed area to be displayed in black.

8. The method according to claim 7, wherein changing the range of the predetermined area comprises changing either the size or position of the predetermined area.

9. The method according to claim 6, wherein an application displayed in the predetermined area comprises a pre-registered application.

10. The method according to claim 9, wherein if a plurality of pre-registered applications including the pre-registered application are started, the applications are changed in order.
